(19) United States
(12) Patent Application Publication
(10) Pub. No.: US 2015/0074017 A1
(43) Pub. Date: Mar. 12, 2015

(54) Market Driven Aural Monitor

(71) Applicant: David Martin, Natick, MA (US)

(72) Inventor: David Martin, Natick, MA (US)

(73) Assignee: FMR LLC, Boston, MA (US)

(21) Appl. No.: 14/023,213

(22) Filed: Sep. 10, 2013

(51) Int. Cl. G06Q 40/06

(52) U.S. Cl. CPC G06Q 40/06
USPC 705/36 R

(57) ABSTRACT

Techniques for conveying market information to users are described. The techniques are computer driven and involve receiving by one or more computers a data stream of current market values for the financial item, applying by the one or more computers the data stream to a rules engine to determine a change value corresponding to a change between a current value of the financial item and a historical value and using by the one or more computers the determined change value to retrieve an audio file according to a selected audio representation, with the change value corresponding to a defined status, e.g., price, trading volume level for the financial item.

### BACKGROUND

This invention relates to market monitoring and more particularly to conveying market information to users.

Real-time market monitoring can involve collection of enormous amounts of data for characterizing how a market is performing. One way to characterize markets is with a stock ticker that displays in text, a stock ticker symbol (typically 1 to 4 letters that represent the entity associated with a security), a price, price change and volume. Another type of stock ticker is a logo ticker that uses an entity's logo in lieu of the ticker symbol to identify the entity. Tickers are often used to characterize pricing movements in indexes, e.g. the S&P 500, The Dow Jones Industrial Average, The NASDAQ 100, etc. While real-time monitoring collect large amounts of data and tickers convey such large amounts of collected data, quick comparisons to get a sense of a trading trend can be inconvenient or complex.

Playlists and mechanisms to generate playlists are commonly found on media players. Typically, playlists are composed of sounds or video clips and are played based on a user-selected configuration and user initiated control.

### SUMMARY

According to an aspect, a method includes receiving by the one or more computers a data stream of current market values for the financial item, applying by the one or more computers the data stream to a rules engine to determine a change value corresponding to a change between a current value of the financial item and a historical value and using by the one or more computers the determined change value to retrieve an audio file according to a selected audio representation of the change value, with the change value corresponding to a defined status level for the financial item.

According to an additional aspect, a computer program product tangibly stored on a computer readable storage device includes instructions for causing a processor to receive a data stream of current market values for the financial item, apply the data stream to a rules engine to determine a change value corresponding to a change between a current value of the financial item and a historical value, and use the determined change value to retrieve an audio file according to a selected audio representation of the change value corresponding to a defined status level for the financial item.

According to an additional aspect, an apparatus includes a processor, memory coupled to the processor, and a computer readable storage device storing a computer program product. The computer program product includes instructions for causing the processor to receive a data stream of current market values for the financial item, apply the data stream to a rules engine to determine a change value corresponding to a change between a current value of the financial item and a historical value, and use the determined change value to retrieve an audio file according to a selected audio representation of the change value corresponding to a defined status level for the financial item.

The following are some of the embodiments with the scope of the above aspects.

The values of the financial item are price values and a set of threshold price bands are retrieved; and a threshold price band corresponding to a current change value in price for the financial item is determined for the current price of the financial item. The audio file is based on the determined threshold band, causing the retrieved audio file to be rendered by a transducer. A playlist is constructed based on user selections of ratings for audio files that are associated with the threshold value bands. An audio file is selected from the playlist based on the determined change value. The audio representations are pre-defined. The audio representations are user-defined. The financial item is at least one of a security, a financial index, a commodity contract, an options contract and other financial product traded on a trading venue. The threshold bands are user defined and correspond to percentage changes in price between a current market price for the financial item and a previous closing price for the financial item. The values of the financial item are trading volume values and a set of threshold trading volume bands are retrieved and a threshold trading volume band corresponding to a current change value in trading volume for the financial item is determined for the current trading volume of the financial item. The data stream is a real time data stream.

Advantages of some or all of these aspects include one or more of the following.

When a market for a financial item goes up or down the market monitoring process renders that movement to a user via audio (sounds) typically as songs from a playlist. The user will have the option to set a number of threshold bands and percentage range values for threshold bands. The computing system can be any sort of user client device or can be a server computing system that generates or retrieves sounds that are rendered by an acoustic transducer element, e.g., speakers, headphones, etc. associated with the client device (e.g., personal computer, tablet computer, smart phone) or can be a stand-alone acoustic transducer that receives the generated/retrieved sounds, via the client device and/or server. Playlists and/or songs on the playlist are selected based on calculations involving an external source, e.g., a market data feed. Playlists/songs are selected and/or controlled by calculations performed by the server and/or client device based on external inputs such as market movements. This enables passive monitoring of market movements through audio without the need for active attention to such movements such as by use of the visual sense and can be useful for all types of users and especially visually impaired users.

The details of one or more embodiments of the invention are set forth in the accompanying drawings and the description below. Other features, objects, and advantages of the invention will be apparent from the description and drawings, and from the claims.

### DESCRIPTION OF DRAWINGS

The accompanied figures are to be used in conjunction with the description below.

FIG. 1 is a block diagram.

FIGS. 2-4 are flow charts for various procedures for a market monitoring process.

FIG. 5 is a diagrammatical view illustrating interrelation of market movements and rated songs on playlists.

The details of one or more embodiments of the invention are set forth in the accompanying drawings and the description below. Other features, objects, and advantages of the invention will be apparent from the description and drawings, and from the claims.

### DETAILED DESCRIPTION

Through a computer system that renders market information as sounds to users, users can passively monitor market activity providing a mechanism to monitor market activity without needing to see numbers. The computing system can be any sort of user client device or can be a server computing system that generates or retrieves sounds that are rendered by an acoustic transducer element, e.g., speakers, headphones, etc. associated with the client device (e.g., personal computer, tablet computer, smart phone) or can be a stand-alone acoustic transducer that receives the generated/retrieved sounds, via the client device and/or server.

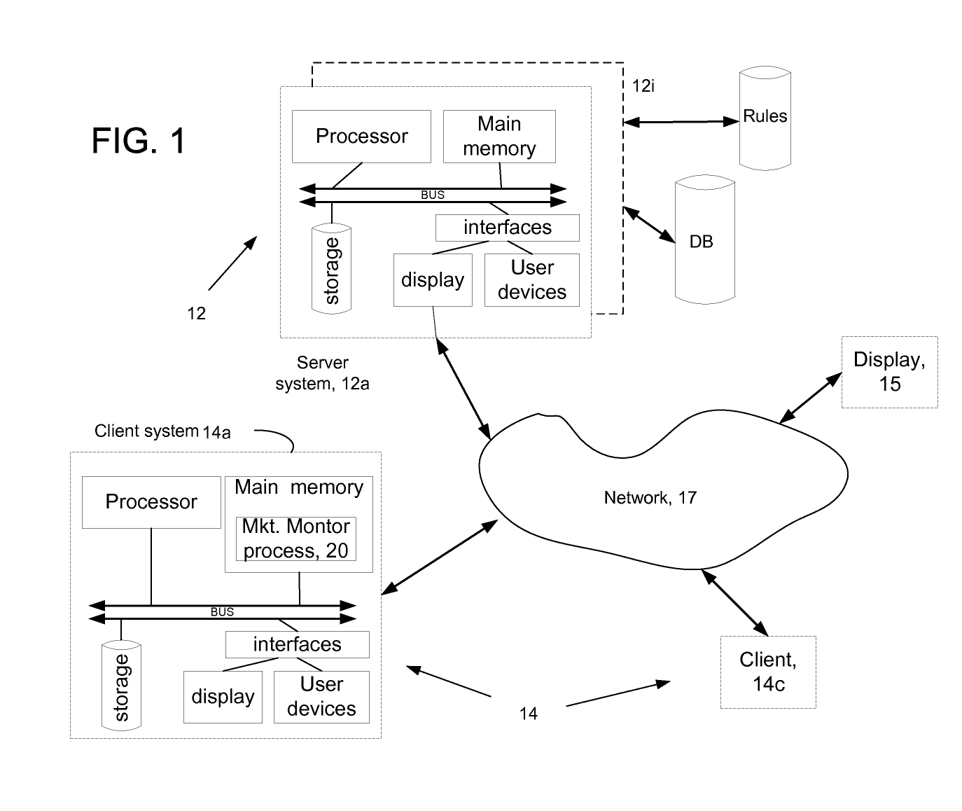

Referring now to FIG. 1, a system 10 includes a server type of computer system 12 comprised of one or more computer systems 12a-12i, one or more client devices, generally 14a-14c generally 14, each computer system 12a-12i and client 14 including a processor, memory and computer storage that stores a computer program product that provides a market monitoring process 20 (as illustrated in memory of device 14a).

In some embodiments, the server 12 produces message streams for client devices 14 from real-time financial information that is sent to the servers. When executed, the computer program product configures the server 12 to send message streams from the server 12 to one or more client devices, generally 14 or stand-alone transducers 15. The message streams include data that renders sounds that represent to the user certain aspects of market information. In other embodiments, the client devices 14 execute the market monitoring process 20, as illustrated. The client devices 14 receive the real-time financial information directly and produce the sounds.

While real-time data would generally be preferred, in some embodiments the data can be delayed, e.g., up to 20 minutes or so. This is because generally distributors of market data may charge fees for the data, with the fees possibly tied to the age of the data. Real-time market data, e.g., less milliseconds or seconds old may command pricing that would not be practical for all users. Thus, in some instances real-time data may not be used, but instead the data would be delayed. Whether real-time or delayed data are used would still be within the scope of the embodiments discussed herein. As used herein the term “current market value” or the like refers to a parameter of a financial item, e.g., price, volume, etc., that is current of the trading day, e.g., a real-time value, a delayed value, or the value at or just before close of trading or the value just after opening of trading and is in contrast to an historical value, e.g. the value at the close of trading of a previous trading day.

The client devices 14 and/or server 12 of the system 10 can access a database that stores historical information and/or user preferences, and audio files. A rules engine that executes on the server 12 and/or the client devices 12 retrieves the user preferences and receives the real-time financial information as well as retrieves historical financial information, e.g., from the database or the like to execute the market monitoring process 20.

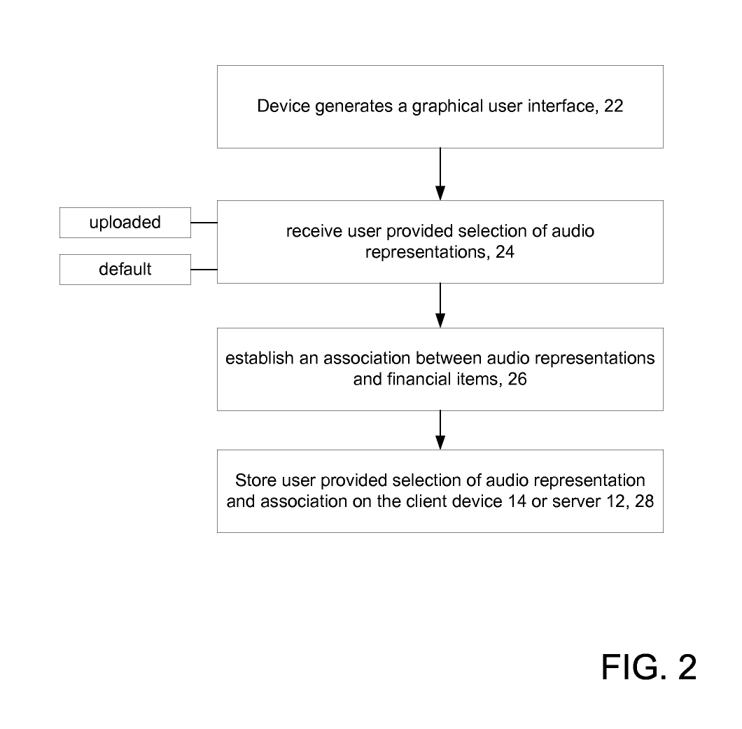

Referring now to FIG. 2, the market monitoring process 20 generates 22 a graphical user interface (not shown). In the graphical user interface provision is made for the user to select the securities or a security to associate with the songs, ranges of price/trading volume levels, number of levels, and so forth.

Users select representations for various financial items through, e.g., the client device 14. The user provided selection 24 of audio representations for one or more financial items are received and are either stored on the client device 14, server 12 and/or in a database 17.

The audio can be of various, types including songs or a user's pre-recorded messages or speech produced from text-to-speech processing. The audio can be merely different, unique sounds. One particular example is a dynamically driven playlist, where either the playlists and/or songs on the playlist are selected based on calculations involving an external source, e.g., a market data feed. In the market monitoring process 20 playlists are selected and/or controlled by calculations performed by the server 12 and/or client devices 14 based on external inputs such as market movements as determined by the server 12 or client device 14.

Users select various sounds, e.g., audio files to represent various financial items of interest to the users or can upload their own audio files. The user establishes an association 26 between audio files and financial items. For example, a financial item can be a security index, e.g., the S&P 500 index. A particular song, message or sound or playlist of songs would be selected by the user to represent each of plural ranges of movements in the index. That is, a user will select a predefined number of levels, with ranges of price movements, and associate a unique song, sound or message or playlist of songs to each of the levels. In an alternative embodiment a playlist can be comprised of, e.g., a number of songs that correspond to the number of levels selected by the user and the song from that playlist would be selected according to the appropriate level that corresponds to price movements as determined by the server. The user-provided selection and associations are stored 28 on the user device 14 and/or server 12.

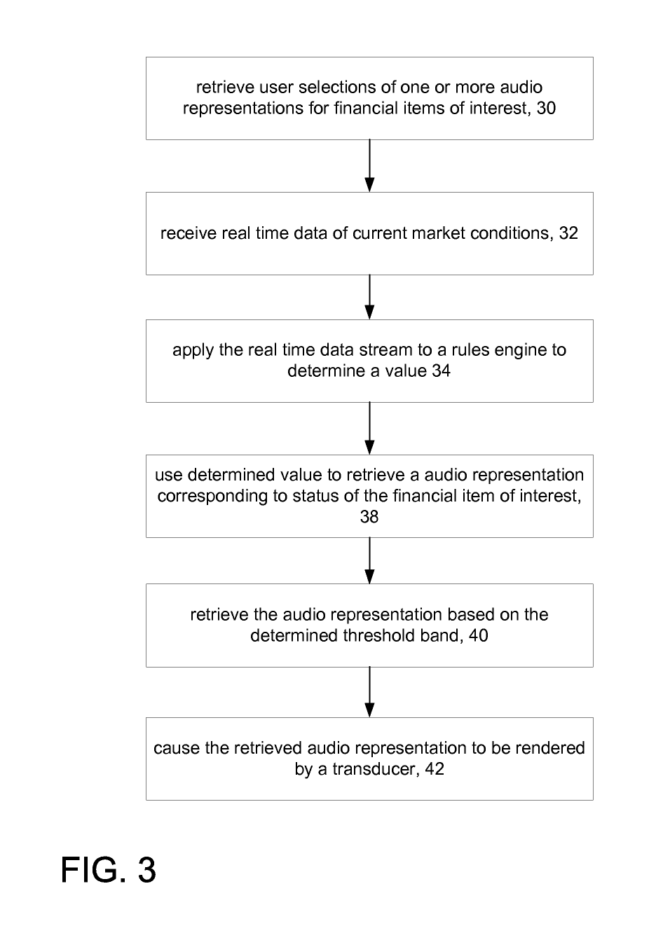

Referring now to FIG. 3, the market monitoring process 20 retrieves 30 user selections of audio representations for those financial items of interest to the user, once the user preferences are set up. These audio representations can be songs, pre-recorded messages or sounds that are stored and indexed according to a value or stored as playlists. In some implementations the messages can be generated messages produced by the market monitoring process 20 and rendered to the user using text-to-speech processing. The market monitoring process 20 periodically, e.g., at regular intervals or continuously, receives 32 real time data of current market conditions including information such as trading prices (and/or volume, discussed below) about the financial item. The market monitoring process 20 applies 34 the real time data stream to a rules engine to determine, e.g., a value 36 that corresponds to a current price of the financial item against a reference price. The determined value is mapped into or correlated to one of a plurality of defined bands or levels of interest pertaining to the financial item. These levels are either user defined or system defined and are associated with particular be songs, pre-recorded messages or sounds. The levels are percentage changes in the current value of the financial item against the reference, typically the prior closing price of the financial item. In other embodiments, other types of processing could be used to determine other types of values pertaining to the financial item.

Once the determined value is mapped to one of the defined bands the market monitoring process 20 uses the determined value to retrieve 38 one or more songs, pre-recorded messages or sounds corresponding to the mapped band or produces a message based on the determined value. The mapping of determined values into the defined bands is performed by the market monitoring process 20 retrieving the set of threshold bands and determining which threshold band contains the value that in this example represents a current change in price against the reference for the financial item. The market monitoring process 20 retrieves 40 the songs, pre-recorded messages or sounds (or generates the message) based on the determined threshold band and causes 42 the retrieved songs, pre-recorded messages or sounds (or generated message) to be rendered through an acoustic transducer either associated with the server 12, the client device 14 or stand-alone transducer 15 from the server 12.

The financial items can be of various types of items represented publically traded financial products such as a security (e.g., stock in publically traded companies), a financial index, a commodity contract, an options contract, a commodities index, as well as and other financial products traded on a trading venue. Financial indexes are comprised of plural financial components.

Threshold Bands

When the market for a financial item goes up or down the market monitoring process 20 renders that movement through audio by selection of different songs and/or playlists. The user will have the option to set a number of threshold bands and percentage range values for threshold bands and associate songs/playlists to those bands.

Table I below shows exemplary percentage bands for changes that would be typical for a market index. In this example there are nine different states:

| | |
|---|---|
| 1. | over +1.5% |
| 2. | +1.01-1.5% |
| 3. | +0.51-1.0% |
| 4. | +0.01-0.05% |
| 5. | neutral market less than 0.01% change +/− |
| 6. | −0.01-0.05% |
| 7. | −0.51-1.0% |
| 8. | −1.01-1.5% |
| 9. | over −1.5% |

The user could decide to only be made aware of major changes. In the system preferences the user has the option to enter their own percentage changes. For example just 3 states:

| | |
|---|---|
| 1. | Really good - anything up over 2% |
| 2. | Really bad - anything down 2% |
| 3. | Marginal changes between +/−2% |

Accordingly any number of percent ranges and values of the percent ranges could be used.

The threshold bands are user defined or system defined and corresponds to percentage changes in price between a current market price for the financial item and a previous closing price for the financial item. In addition, the bands could be based on relative volatility of the financial item with those financial items having relatively high price volatility (large intra-day price swings) having larger bands than those financial item with relatively low price volatility.

The market monitoring process 20 uses representations for the various financial items, where the representations are audio files. For mapping the user would associate a particular set of songs, pre-recorded messages or sounds to each range. Thus in the example above that tracks only major changes, the user enters an identifier for a particular set of songs, pre-recorded messages or sounds to each range. For example for the three states:

| | | |
|---|---|---|
| 1. | Really good - anything up over 2% | audio file 4; playlist 2 |
| 2. | Really bad - anything down 2% | audio file 17; playlist 7 |
| 3. | Marginal changes between +/−2% | audio file 10; playlist 5 |

It is understood that the audio files or playlists mentioned above are illustrative only. If a user chose a playlist then any song on that list could be rendered to the user. For example, the playlists could be selected based on genre, with one type, e.g., classical representing marginal changes, heavy metal representing really bad changes and folk representing really good changes.

For audio files recorded by the user these could be user recorded words or sentences into the mobile device or can be canned messages with placeholders “< >” for values that are inserted into the messages. The values can be the percentage changes calculated above or can be user-defined states mentioned above. Exemplary messages include:

a. “The market in <financial item> is up <n>%”

b. “No significant change today in the market in <financial item>”

c. “The market in <financial item> is down <n>%”

where <financial item> is the item being monitored and <n> is the calculated percent change in price.

More sophisticated exemplary processing could uncover trading anomalies, e.g., sudden increases in trading volume or large number of block trades and compose messages that convey that to the user, e.g., by text-to-speech synthesis.

d. “<financial item> is trading up with <j> shares traded of which <m> were block sized trades.”

e. “<financial item> is trading down with <j> shares traded of which <m> were block sized trades.”

f. “<financial item> is trading flat”

where <financial item> is the item being monitored, <j> is the number of shares traded and <m> is the number of block sized trades (typically trades of 10,000 shares).

These messages can be generated by the server 12 or client device 14 and will more specifically inform the user about specific market conditions. These messages can be constructed digitally, and text-to-speech processing can be used to convey content to the user.

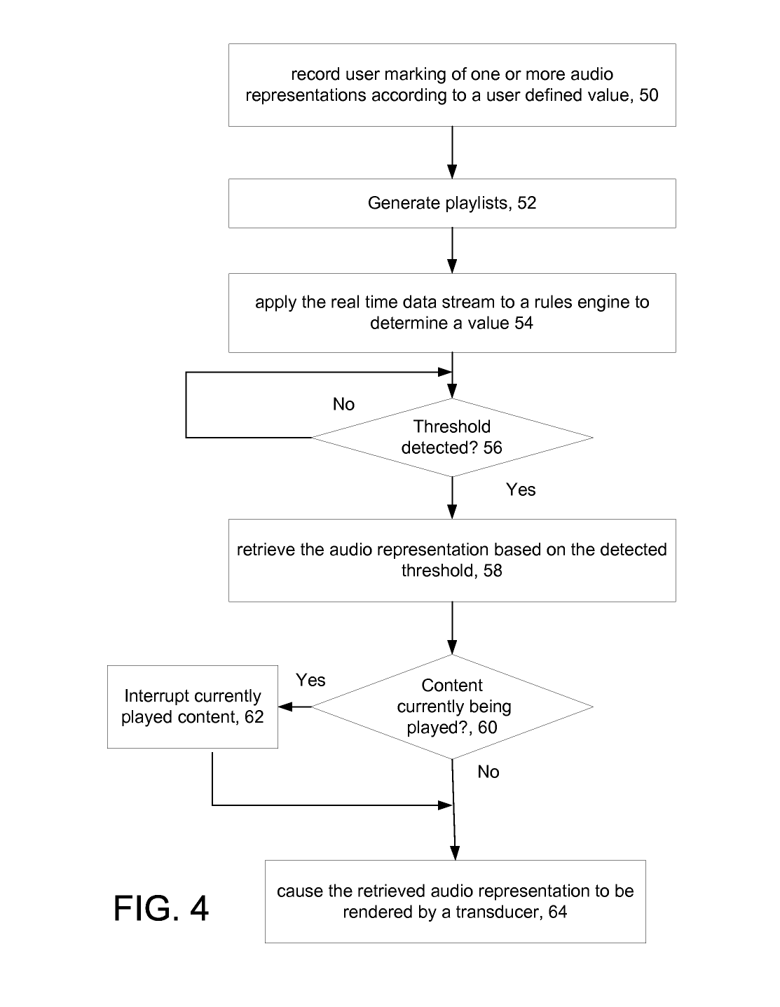

Referring now to FIG. 4 an exemplary technique is shown. This technique uses playlists that can be of any type of sound or song or message. In the market monitoring process 20, executing on the server system 12 or client 14, the user “mark” songs or other prerecorded audio file in a way that is recognizable to the user. The user picks audio files/songs according to particular market conditions, e.g., based on the calculated values above, for example. Because marking of the files/songs in the system is based on the calculated values, this is akin to a star rating and when the market monitoring process 20 produced the determined value, the song selected will be according to the user-selected rating.

For example, in the example above where there were nine states the user can mark the songs/files from (−4, −3, −2, −1, 0, +1, +2, +3, +4), which would correspond to states “9” to “1” set out above. In this example, the user produces 52 nine groupings. The groupings can be nine playlists, e.g., of songs, with the playlists each containing one or more songs, e.g., of, e.g., the same genre/artist (or another user-selected factor) that would be rendered according to the calculated value and mapping. Alternatively, a single playlist of nine songs can be provided where the song is selected according to the determined value.

The system monitors the market using market data streams available through existing feeds to determine the value 54, discussed above. When predefined thresholds of market movement are detected 56, the system will retrieve 58 the audio representation based on the detected value. The system will determine if a song is being played 60 and if so, interrupt the song 62 and otherwise plays 62 a song/file associated with the retrieved audio representation.

Thus, the user can set up a preference where if a major market movement is detected the song/audio file is interrupted (not allowed to finish) and a new song/audio file appropriate to the new market condition plays. That would give the user near real-time monitoring of meaningful market events without having to have visual interaction with market data. The particular song selected is derived from the condition of the market for the financial item. This would free the user from having to be in constant visual contact with a monitor/display device that a textually conveys market data.

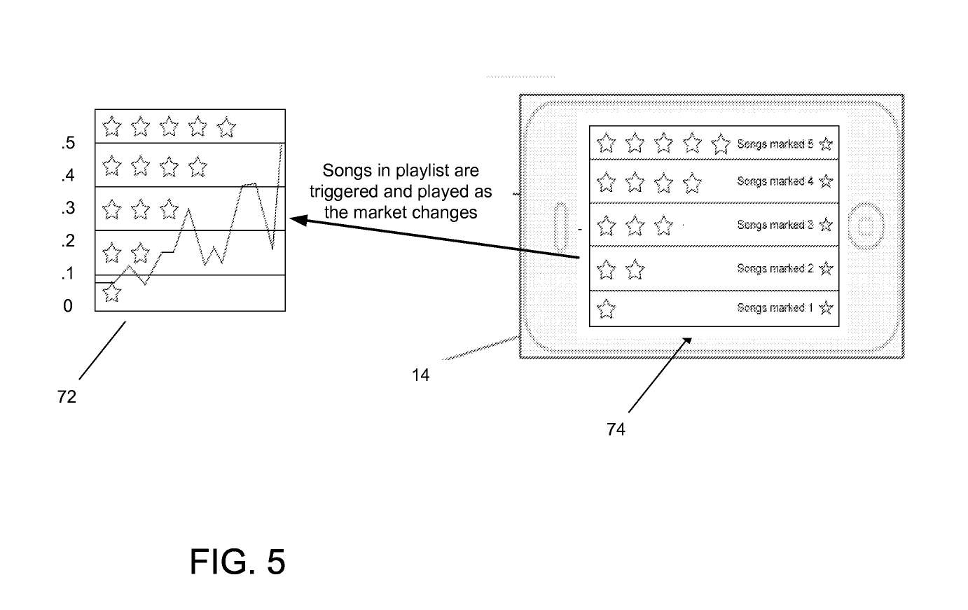

Referring now to FIG. 5, an exemplary depiction of playlists correlated to market movements is shown. A set of ratings 72 (stars) are shown mapped with percentage changes, with an illustrative graph representing intra-day pricing superimposed over the set of ratings. A client device 14 is also shown with an audio/media player window 74 opened depicting songs having star ratings. The audio player can be used to render the songs according to the star ratings that are selected based on the calculated, determined value discussed above.

The representations can be stored as objects in a database and are called by the market monitor process 20 when predefined market conditions are met. The database would be set up to use unique identifiers for each object. The objects would be mapped to percentage changes, called and shown when that condition is met.

The server can be any of a variety of computing devices capable of receiving information, such as a server, a distributed computing system, a desktop computer, a laptop, a cell phone, a rack-mounted server, and so forth. Server may be a single server or a group of servers that are at a same location or at different locations.

Server can receive information from client devices via interfaces. Interfaces can be any type of interface capable of receiving information over a network, such as an Ethernet interface, a wireless networking interface, a fiber-optic networking interface, a modem, and so forth. Server also includes a processor and memory. A bus system (not shown), including, for example, an information bus and a motherboard, can be used to establish and to control information communication between the components of server.

Processor may include one or more microprocessors. Generally, processor may include any appropriate processor and/or logic configured for receiving and storing information, and of communicating over a network (not shown). Memory can include a hard drive and a random access memory storage device, such as a dynamic random access memory, machine-readable media, or other types of non-transitory machine-readable storage devices.

Components also include storage device, which is configured to store information, map, map templates, rules information for the rules, software for the rules engine, etc.

Embodiments can be implemented in digital electronic circuitry, or in computer hardware, firmware, software, or in combinations thereof. Apparatus can be implemented in a computer program product tangibly embodied or stored in a machine-readable storage device and/or machine readable media for execution by a programmable processor; and method actions can be performed by a programmable processor executing a program of instructions to perform functions and operations by operating on input information and generating output. Aspects can be implemented advantageously in one or more computer programs that are executable on a programmable system including at least one programmable processor coupled to receive information and instructions from, and to transmit information and instructions to, a information storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and information from a read-only memory and/or a random access memory. Generally, a computer will include one or more mass storage devices for storing information files; such devices include magnetic disks, such as internal hard disks and removable disks; magneto-optical disks; and optical disks as well as solid state disk drives. Storage devices suitable for tangibly embodying computer program instructions and information include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

A number of embodiments of the invention have been described. Nevertheless, it will be understood that various modifications may be made without departing from the spirit and scope of the invention. For example, while discussion has focused on price changes, the principals above could be applied to volume changes to depict market activity. In such a use, the values of the financial item that are used in calculations would be trading volume values, and the set of threshold bands would be trading volume bands, e.g., number of shares traded over a period, e.g., a day an week, an hour, etc. The market monitoring process would determine for the current volume of trading in the financial item a threshold trading volume band that corresponds to a current change value in trading volume for the financial item and would select audio associated with the determined trading volume band. Accordingly, other embodiments are within the scope of the following claims.

1. A method, comprising:
receiving by the one or more computers a data stream of current market values for the financial item;
determining by the one or more computers based on the data stream a change value corresponding to a difference between a current value of the financial item and a historical value of the financial item;
mapping by the one or more computers the determined change value of the financial item to a set of predefined levels to provide a determined status level for the financial item; and
retrieving by the one or more computers based on the determined status level an audio file associated with the financial item, with the audio file selected as an audio representation of the determined status level for the financial item.

2. The method of claim 1, wherein the values of the financial item are price values and applying further comprises:
retrieving a set of threshold price bands; and
determining for the current price of the financial item the determined status level as a threshold price band corresponding to a current change value in price for the financial item.

3. The method of claim 2 further comprising:
retrieving the audio file based on the determined threshold band;
causing the retrieved audio file to be rendered by a transducer.

4. The method of claim 1 further comprising:
constructing by the one or more computers a playlist based on user selections of ratings for audio files that are associated with the threshold value bands.

5. The method of claim 4 further comprising:
selecting by the one or more computers an audio file from the playlist, with selecting being based on the determined status level.

6. The method of claim 1 wherein the audio representations are pre-defined.

7. The method of claim 1 wherein the audio representations are user-defined.

8. method of claim 1 wherein the financial item is at least one of a security, a financial index, a commodity contract, an options contract, an exchange traded fund, and a financial product traded on a trading venue.

9. The method of claim 1 wherein the threshold bands are user defined and correspond to percentage changes in price between a current market price for the financial item and a previous closing price for the financial item.

10. The method of claim 1, wherein the values of the financial item are trading volume values and applying further comprises:
retrieving a set of threshold trading volume bands; and
determining for the current trading volume of the financial item the determined status level as a threshold trading volume band corresponding to a current change value in trading volume for the financial item.

11. The method of claim 1 wherein the data stream is a real time data stream.

12. A computer program product tangibly stored on a computer readable hardware storage device, the computer program product comprising instructions for causing a processor to:
receive a data stream of current market values for the financial item;
determine from the data stream a change value corresponding to a difference between a current value of the financial item and a historical value of the financial item;
map the determined change value of the financial item to a set of predefined levels to provide a determined status level for the financial item; and
retrieve based on the determined status level an audio file associated with the financial item, with the audio file selected as an audio representation of the determined status level for the financial item.

13. The computer program product of claim 12 wherein the values of the financial item are price values and instructions to apply further comprise instructions to:
retrieve a set of threshold price bands; and
determine for the current price of the financial item the determined status level as a threshold price band corresponding to a current change value in price for the financial item.

14. The computer program product of claim 13 further comprising instructions to:
retrieve the audio file based on the determined threshold band;
cause the retrieved audio file to be rendered by a transducer.

15. The computer program product of claim 12 further comprising instructions to:
construct a playlist based on user selections of ratings for audio files that are associated with the threshold value bands.

16. The computer program product of claim 15, further comprising instructions to:
select an audio file from the playlist, with the instructions selecting the file based on the determined status level.

17. The computer program product of claim 12 wherein the financial item is at least one of a security, a financial index, a commodity contract, an options contract an exchange traded fund, and a financial product traded on a trading venue.

18. The computer program product of claim 13 wherein the threshold bands are user defined and correspond to percentage changes in price between a current market price for the financial item and a previous closing price for the financial item.

19. The computer program product of claim 12 wherein the values of the financial item are trading volume values and instructions to apply comprise instructions to:
retrieve a set of threshold trading volume bands; and
determine for the current trading volume of the financial item the determined status level as a threshold trading volume band corresponding to a current change value in trading volume for the financial item.

20. The computer program product of claim 13 wherein the data stream is a real time data stream.

21. An apparatus comprising:
a processor;
memory coupled to the processor;
a computer readable storage device storing a computer program product, the computer program product comprising instructions for causing the processor to:
receive a data stream of current market values for the financial item;
apply the data stream to a rules engine to determine a change value corresponding to a difference between a current value of the financial item and a historical value of the financial item;
map the determined change value of the financial item to a set of predefined levels to provide a determined status level for the financial item; and
retrieve based on the determined status level an audio file associated with the financial item, with the audio file selected as an audio representation of the determined status level for the financial item.

22. The apparatus of claim 21 wherein the values of the financial item are price values and instructions to apply further comprise instructions to:
retrieve a set of threshold price bands; and
determine for the current price of the financial item the determined status level as a threshold price band corresponding to a current change value in price for the financial item.

23. The apparatus of claim 22 further comprising instructions to:
retrieve the audio file based on the determined threshold band;
cause the retrieved audio file to be rendered by a transducer.

24. The computer program product of claim 21 further comprising instructions to:
construct a playlist based on user selections of ratings for audio files that are associated with the threshold value bands.

25. The computer program product of claim 24, further comprising instructions to:
select an audio file from the playlist, with the instructions selecting the file based on the determined status level.

26. The apparatus of claim 21 wherein the financial item is at least one of a security, a financial index, a commodity contract, an options contract, an exchange traded fund, and a financial product traded on a trading venue.

27. The apparatus of claim 21 wherein the threshold bands are user defined and correspond to percentage changes in price between a current market price for the financial item and a previous closing price for the financial item.

28. The apparatus of claim 21 wherein the values of the financial item are trading volume values and instructions to apply comprise instructions to:
retrieve a set of threshold trading volume bands; and
determine for the current trading volume of the financial item the determined status level as a threshold trading volume band corresponding to a current change value in trading volume for the financial item.

29. The apparatus of claim 21 wherein the data stream is a real time data stream.
